(19) United States
(12) Patent Application Publication
(10) Pub. No.: US 2025/0086312 A1
(43) Pub. Date: Mar. 13, 2025

(54) AUTHENTICATION SYSTEM, AUTHENTICATION DEVICE, AND STORAGE MEDIUM STORING AUTHENTICATION PROGRAM

(71) Applicant: Denso Corporation, Kariya-City (JP)

(72) Inventors: Ryota SAITO, Kariya-City (JP); Yoshitaka TANEMURA, Kariya-City (JP)

(21) Appl. No.: 18/958,417

(22) Filed: Nov. 25, 2024

Related U.S. Application Data
(63) Continuation of application No. PCT/JP2023/023011, filed on Jun. 21, 2023.

(30) Foreign Application Priority Data
Jun. 29, 2022 (JP) 2022-104543

(51) Int. Cl. G06F 21/62; G06F 21/32; G06F 21/60

(52) U.S. Cl. CPC G06F 21/6245; G06F 21/32; G06F 21/604

(57) ABSTRACT

An authentication system includes at least one service application, a vehicle function block, an authentication authorization management unit, a confidential information management table, and an authorization process management table. The at least one service application provides a service to a user utilizing a vehicle. The vehicle function block acquires the vehicle information. The authentication authorization management unit determines whether to authorize a confidential information acquisition request. The confidential information management table defines a user who has authorization rights for each confidential information. The authorization process management table defines an authorization process for authorizing the confidential information acquisition request for each of a plurality of users and for each of the plurality of confidential information. The authentication authorization management unit determines the authorization process based on the confidential information management table and the authorization process management table, and determines whether to authorize the confidential information acquisition request.

### CROSS REFERENCE TO RELATED APPLICATION

The present application is a continuation application of International Patent Application No. PCT/JP2023/023011 filed on Jun. 21, 2023 which designated the U.S. and claims the benefit of priority from Japanese Patent Application No. 2022-104543 filed on Jun. 29, 2022. The entire disclosures of all of the above applications are incorporated herein by reference.

### TECHNICAL FIELD

The present disclosure relates to an authentication system, an authentication device, and an authentication program.

### BACKGROUND

A related art describes an authentication system that includes a plurality of terminal devices mounted on a vehicle and a center connected to the plurality of terminal devices via a network. The system switches the authentication method for users utilizing the terminal devices based on the usage of the terminal devices. For example, when the terminal device is mounted on a private vehicle, an authentication method using an ID and password is selected. When the terminal device is mounted on a rental car, an authentication method using a mobile terminal possessed by the rental car user is selected, thereby switching the authentication method.

### SUMMARY

An authentication system includes at least one service application, a vehicle function block, an authentication authorization management unit, a confidential information management table, and an authorization process management table. The at least one service application provides a service to a user utilizing a vehicle. The vehicle function block acquires the vehicle information. The authentication authorization management unit determines whether to authorize a confidential information acquisition request. The confidential information management table defines a user who has authorization rights for each confidential information. The authorization process management table defines an authorization process for authorizing the confidential information acquisition request for each of a plurality of users and for each of the plurality of confidential information. The authentication authorization management unit determines the authorization process based on the confidential information management table and the authorization process management table, and determines whether to authorize the confidential information acquisition request.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating the configuration of a vehicle control system;

FIG. 2 is a functional block diagram illustrating the functional configuration of the vehicle control system;

FIG. 3 is a functional block diagram illustrating the functional configuration of an ECU;

FIG. 4 is a diagram illustrating the configuration of a privacy information management table;

FIG. 5 is a diagram illustrating the configuration of an authorization process management table;

FIG. 6 is a diagram explaining the linkage between current location information and an owner;

FIG. 7 is a sequence diagram illustrating the procedure when a service application acquires data;

FIG. 8 is a sequence diagram illustrating the procedure when the authentication authorization management unit determines the authorization process; and

FIG. 9 is a sequence diagram illustrating the procedure until the access control unit transmits a user authentication request.

### DETAILED DESCRIPTION

In recent years, the spread of car sharing has progressed, and the opportunities for a single vehicle to be shared by multiple users have increased. When a single vehicle is shared by multiple users, confidential information for each user generated by the use of the vehicle by multiple users is stored within the same vehicle. The authority holder who has authorization rights for the confidential information varies depending on the content of the confidential information.

Additionally, the number of vehicles equipped with applications configured to acquire vehicle information from the vehicle and provide predetermined services to the vehicle users is increasing.

As a result of detailed consideration by the inventors, it has been found that if the confidential information stored in the vehicle is not properly managed, there may be a difficulty that the application may not be able to acquire the necessary confidential information and thus fail to provide appropriate services, or that confidential information that should not be provided may be provided to the application.

The present disclosure provides a technique to improve the convenience for vehicle users and to suppress the inappropriate acquisition of confidential information.

According to an aspect of the present disclosure, an authentication system includes at least one service application, a vehicle function block, an authentication authorization management unit, a confidential information management table, and an authorization process management table.

The at least one service application is configured to provide a service to a user utilizing the vehicle by using vehicle information related to the vehicle.

The vehicle function block is configured to acquire vehicle information held by an electronic control unit mounted on the vehicle.

The authentication authorization management unit is configured to determine whether to authorize a confidential information acquisition request when at least one service application issues a confidential information acquisition request to acquire confidential information among the vehicle information via the vehicle function block.

The confidential information management table defines the user who has authorization rights for each of the plurality of confidential information.

The authorization process management table defines an authorization process for authorizing the confidential information acquisition request for each of the plurality of users and for each of the plurality of confidential information.

The authentication authorization management unit determines the authorization process based on the confidential information management table and the authorization process management table, and determines whether to authorize the confidential information acquisition request using the determined authorization process.

In the authentication system of the present disclosure configured in such a manner, when a confidential information acquisition request is made by a service application, the user who has authorization rights for the confidential information that is the target of the confidential information acquisition request is identified. Furthermore, the system determines whether to authorize the confidential information acquisition request using the authorization process determined for each vehicle user and for each confidential information. If necessary, the authentication system of the present disclosure can include a process that requires approval from the user who has authorization rights in the authorization process.

Thus, the authentication system of the present disclosure can determine whether to provide the confidential information that is the target of the confidential information acquisition request to the service application based on the authorization process determined based on the user who has authorization rights, the vehicle user, and the confidential information. As a result, the authentication system of the present disclosure can prevent the occurrence of a situation in which the application cannot acquire the necessary confidential information and thus fails to provide appropriate services to the vehicle user, or confidential information that should not be provided is provided to the application. Therefore, the authentication system of the present disclosure can improve the convenience for vehicle users and suppress the inappropriate acquisition of confidential information.

According to another aspect of the present disclosure, an authentication device includes an authentication authorization management unit, a confidential information management table, an authorization process management table, and a vehicle function block.

The vehicle function block is configured to acquire confidential information when the confidential information acquisition request is authorized by the authentication authorization management unit.

The authentication authorization management unit determines the authorization process based on the confidential information management table and the authorization process management table, and determines whether to authorize the confidential information acquisition request using the determined authorization process.

The authentication device of the present disclosure configured in such a manner is a device that constitutes the authentication system of the present disclosure, and can achieve the same effects as the authentication system of the present disclosure.

According to yet another aspect of the present disclosure, an authentication program causes a computer to function as an authentication authorization management unit and a vehicle function block.

A computer controlled by the authentication program of the present disclosure can constitute a part of the authentication device of the present disclosure and can achieve the same effects as the authentication device of the present disclosure.

According to yet another aspect of the present disclosure, an authentication system includes a first electronic control unit that manages vehicle information related to a vehicle and a second electronic control unit that has a function of relaying data transmitted from a plurality of first electronic control units.

The first electronic control unit includes a first storage and a first vehicle function block. The first storage is configured to store vehicle information. The first vehicle function block is configured to acquire vehicle information.

The second electronic control unit includes at least one service application, a second vehicle function block, an authentication authorization management unit, a confidential information management table, and an authorization process management table. The second vehicle function block is configured to acquire vehicle information from the first electronic control unit. The authentication authorization management unit determines the authorization process based on the confidential information management table and the authorization process management table, and determines whether to authorize the confidential information acquisition request using the determined authorization process. When the confidential information acquisition request is authorized by the authentication authorization management unit, the at least one service application acquires the confidential information via the first vehicle function block of the first electronic control unit or the second vehicle function block of the second electronic control unit that stores the confidential information corresponding to the confidential information acquisition request.

The authentication system of the present disclosure configured in such a manner can improve the convenience for vehicle users and suppress the inappropriate acquisition of confidential information.

Hereinafter, embodiments of the present disclosure will be described with reference to the drawings.

A vehicle control system 1 of the present embodiment is mounted on a vehicle. The vehicle may have an automated driving function in addition to a manual driving function. The vehicle may be a hybrid vehicle having an engine and an electric motor as a driving source. The vehicle is not limited to a vehicle having the automated driving function or a hybrid vehicle, but may be a vehicle having only a manual driving function, or a vehicle having only an engine or only an electric motor as the driving source. Hereinafter, the vehicle equipped with the vehicle control system 1 will be simply referred to as a vehicle.

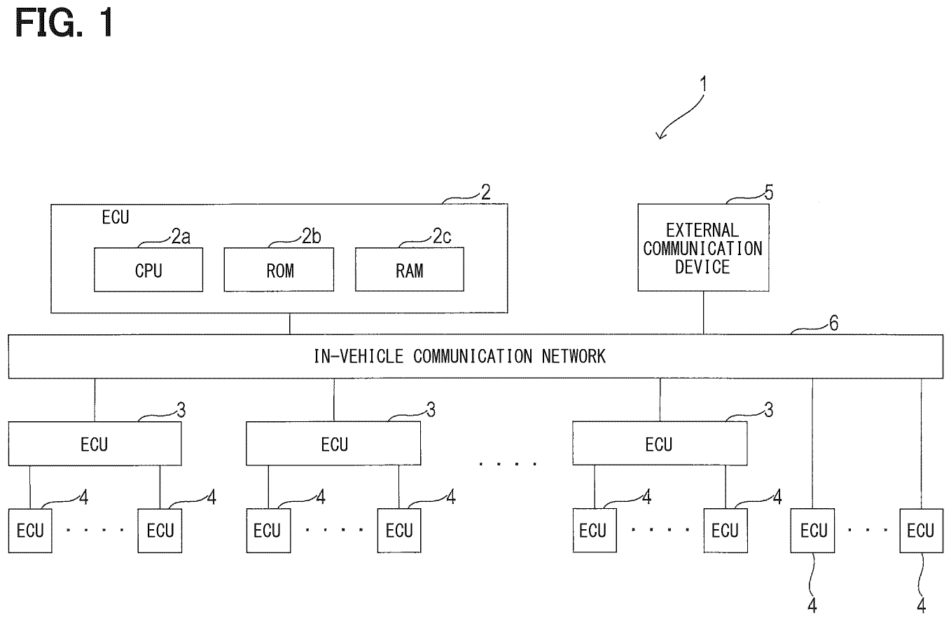

As shown in FIG. 1, the vehicle control system 1 includes an ECU 2, a plurality of ECUs 3, a plurality of ECUs 4, a vehicle exterior communication device 5, and an in-vehicle communication network 6. The ECU is an abbreviation for Electronic Control Unit.

The ECU 2 controls the plurality of ECUs 3 and 4 to achieve coordinated control of the vehicle as a whole. The ECU 2 has a function of relaying data transmitted by the ECUs 3 and 4 to the in-vehicle communication network 6.

The ECU 3 is provided for each domain divided by function in the vehicle, and mainly controls a plurality of ECUs 4 existing within that domain. Each ECU 3 is connected to its subordinate ECUs 4 via a lower-layer network (for example, CAN) provided individually. The CAN is an abbreviation for Controller Area Network. The CAN is a registered trademark. The domains include, for example, powertrain, body, chassis, and cockpit.

An ECU 4 connected to an ECU 3 belonging to the powertrain domain includes, for example, an ECU 4 that controls the engine, an ECU 4 that controls the motor, and an ECU 4 that controls the battery.

An ECU 4 connected to an ECU 3 belonging to the body domain includes, for example, an ECU 4 that controls the air conditioner and an ECU 4 that controls the doors.

An ECU 4 connected to an ECU 3 belonging to the chassis domain includes, for example, an ECU 4 that controls the brakes and an ECU 4 that controls the steering.

An ECU 4 connected to an ECU 3 belonging to the cockpit domain includes, for example, an ECU 4 that controls the display of a meter and a navigation device, and an ECU 4 that controls input devices operated by a vehicle occupant.

One or more ECUs 4 are not assigned to any domain and are directly connected to the in-vehicle communication network 6 without passing through an ECU 3.

The vehicle external communication device 5 performs data communication with a communication device outside the vehicle via a wide area wireless communication network.

The in-vehicle communication network 6 includes CAN FD and Ethernet. The Ethernet is a registered trademark. The CAN FD is an abbreviation for CAN with Flexible Data Rate. The CAN FD bus-connects the ECUs 4, the ECUs 3, and the vehicle external communication device 5. The Ethernet individually connects the ECUs 4, the ECUs 3, and the vehicle external communication device 5.

The ECU 2 is an electronic control unit mainly including a microcomputer with a CPU 2a, a ROM 2b, a RAM 2c, and the like. Various functions of the microcomputer are implemented by the CPU 2a executing a program stored in a non-transitory tangible storage medium. In this example, the ROM 2b corresponds to the non-transitory tangible storage medium in which the program is stored. A method corresponding to the program is executed by executing the program. A part or all of the functions to be executed by the CPU 2a may be configured in hardware by one or multiple ICs or the like. The number of microcomputers included in the ECU 2 may be one or more.

The ECUs 3, ECUs 4, and the vehicle external communication device 5 are all electronic control units mainly including a microcomputer with a CPU, ROM, RAM, and the like, similarly to the ECU 2. The number of microcomputers included in the ECUs 3, ECUs 4, and the vehicle external communication device 5 may be one or more. The ECU 3 controls one or more ECUs 4. The ECU 2 controls one or more ECUs 3 or controls the entire vehicle including the ECUs 3, ECUs 4, and the vehicle external communication device 5.

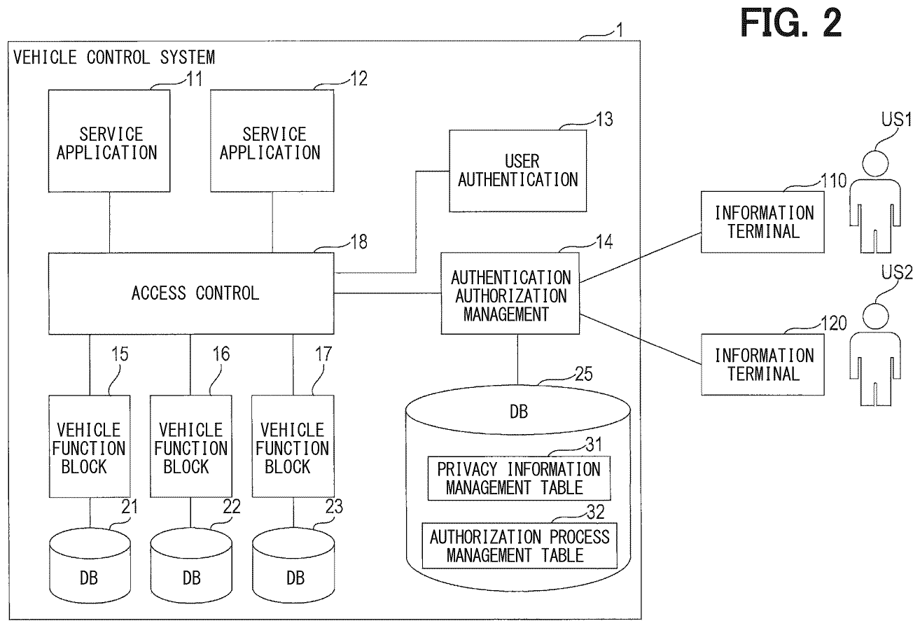

As shown in FIG. 2, the vehicle control system 1 includes service applications 11 and 12, a user authentication unit 13, an authentication authorization management unit 14, vehicle function blocks 15, 16, and 17, an access control unit 18, vehicle function databases 21, 22, and 23, and an authorization policy database 25.

The service applications 11 and 12 are applications manufactured to provide a service to a vehicle user.

Services provided to vehicle users include, for example, services that control the air conditioner to wake up the driver or control wipers to improve the driver's visibility in response to weather changes and the driver level of fatigue along a vehicle traveling schedule route. In the above service, for example, it is necessary to acquire from inside the vehicle, information on the traveling schedule route, vehicle interior temperature information, vehicle exterior temperature information, current vehicle position information, driver age information, driver gender information, and driver body temperature information. Furthermore, the above service requires acquisition of rainy road information for the traveling schedule route from, for example, a social infrastructure platform outside the vehicle. Among the above information acquired from inside the vehicle, the vehicle current position information, the driver age information, gender information, and body temperature information correspond to privacy information.

The service applications 11 and 12 provide different services to the vehicle user.

The user authentication unit 13 is an application that authenticates the vehicle user (i.e., the driver).

The authentication authorization management unit 14 is an application that authorizes access from the service applications 11 and 12. The authentication authorization management unit 14 determines whether to authorize access by performing data communication with an information terminal 110 possessed by a vehicle user US1 and an information terminal 120 possessed by a vehicle user US2, for example.

The vehicle function blocks 15, 16, and 17 are applications that collect vehicle information and control the vehicle to provide services to vehicle users. The vehicle function blocks 15, 16, and 17 provide different services to the vehicle users.

The vehicle information includes, for example, vehicle speed, engine speed, steering angle, acceleration, and position. This vehicle information is stored by the ECU 4 that controls the engine, the ECU 4 that controls the steering, the ECU 4 that controls the airbags, and the vehicle external communication device 5.

The vehicle information may also include an image captured by an in-vehicle camera and an image captured by an exterior camera. This vehicle information is stored by the ECU 4 that controls the camera.

The vehicle information may also include addresses registered in the navigation device. This address information is stored by the navigation device connected to the ECU 2.

The access control unit 18 is an application that provides messaging processing to manage the exchange of messages between the service applications 11 and 12, the user authentication unit 13, the authentication authorization management unit 14, and the vehicle function blocks 15 and 16. In the present embodiment, the access control unit 18 is, for example, an in-vehicle software platform that complies with AUTOSAR. AUTOSAR is an abbreviation for Automotive Open System Architecture. AUTOSAR is a registered trademark.

The vehicle function databases 21, 22, and 23 store vehicle information collected by the vehicle function blocks 15, 16, and 17, respectively.

The authorization policy database 25 stores the privacy information management table 31 and the authorization process management table 32, which will be described later.

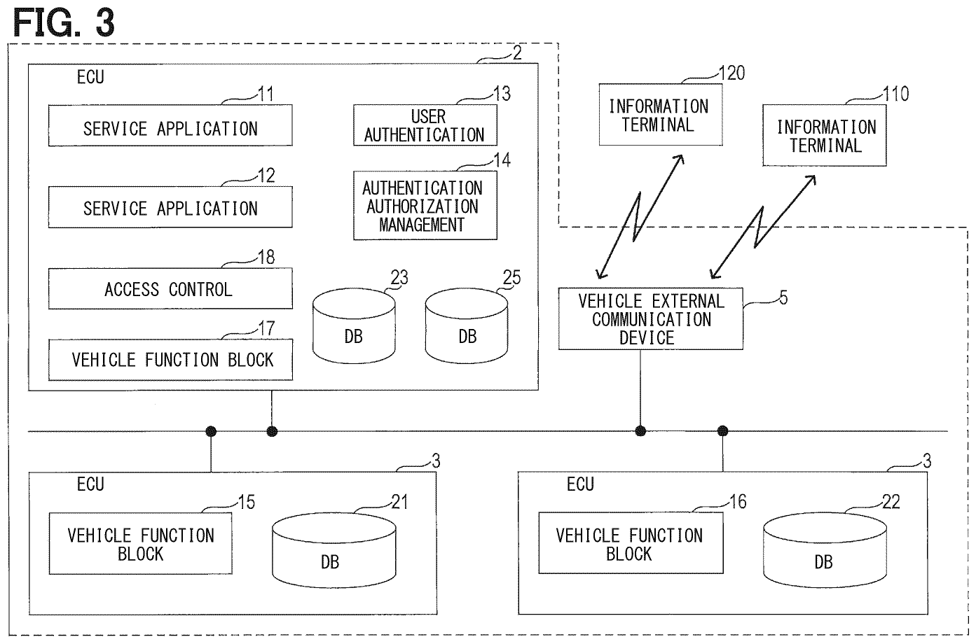

As shown in FIG. 3, the service applications 11 and 12, the user authentication unit 13, the authentication authorization management unit 14, the vehicle function block 17, the access control unit 18, the vehicle function database 23, and the authorization policy database 25 are installed in the ECU 2.

The vehicle function block 15 and the vehicle function database 21 are installed in one of the plurality of ECUs 3. The vehicle function block 15 collects vehicle information from the ECU 3 in which the vehicle function block 15 is installed and from the ECUs 4 connected to this ECU 3.

The vehicle function block 16 and the vehicle function database 22 are installed in one of the ECUs 3 different from the ECU 3 in which the vehicle function block 15 and the vehicle function database 21 are installed. The vehicle function block 16 collects vehicle information from the ECU 3 in which the vehicle function block 16 is installed and from the ECUs 4 connected to this ECU 3.

The vehicle function block 17 collects vehicle information from the ECU 2 in which the vehicle function block 17 is installed and from the ECUs 4 directly connected to the in-vehicle communication network 6. The vehicle function block 17 may also collect vehicle information from the ECUs 3.

The vehicle external communication device 5 performs data communication with the information terminals 110 and 120.

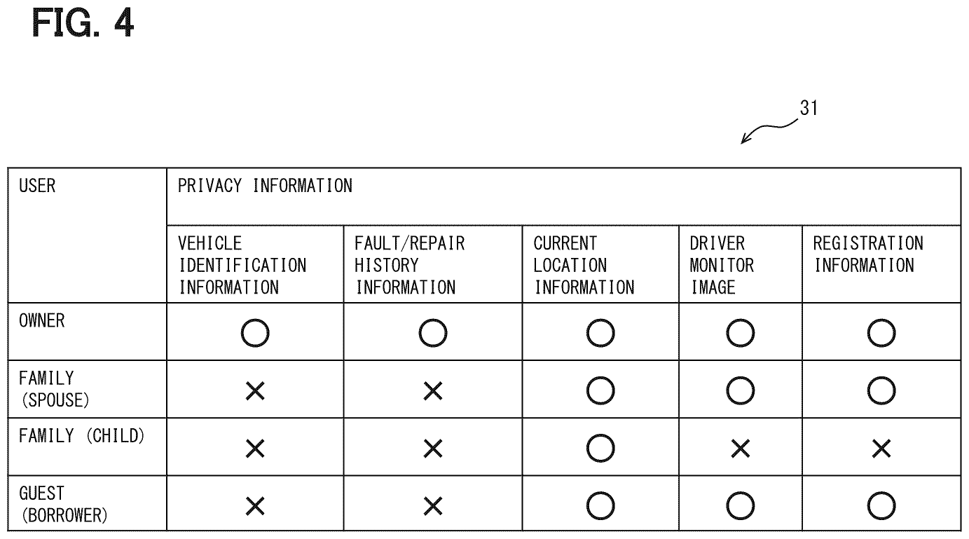

As shown in FIG. 4, the privacy information management table 31 sets whether each of the plurality of users has authorization rights for each of the plurality of privacy information. Authorization rights refer to the authority to permit the use of privacy information by an application.

The privacy information management table 31 shown in FIG. 4 indicates that the vehicle owner has authorization rights for vehicle identification information, fault/repair history information, current location information, a driver monitor image, and registration information (name, age, gender) set as privacy information. Here, the privacy information management table 31 indicates that the vehicle owner has authorization rights for the current location information when the owner uses the vehicle, the driver's monitor image of the owner, and the registration information of the owner. The privacy information management table 31 may also be set to indicate that the vehicle owner has authorization rights for the current location information when others use the vehicle.

The privacy information management table 31 indicates that the spouse of the vehicle owner has authorization rights for current location information, a driver monitor image, and registration information. The privacy information management table 31 indicates that the spouse of the vehicle owner does not have authorization rights for vehicle identification information and fault/repair history information.

The privacy information management table 31 indicates that the child of the vehicle owner has authorization rights for current location information. The privacy information management table 31 indicates that the child of the vehicle owner does not have authorization rights for the child's own driver monitor image and registration information.

The privacy information management table 31 indicates that a guest (i.e., a borrower of the vehicle) has authorization rights for current location information, a driver monitor image, and registration information. The privacy information management table 31 indicates that the guest does not have authorization rights for vehicle identification information and fault/repair history information.

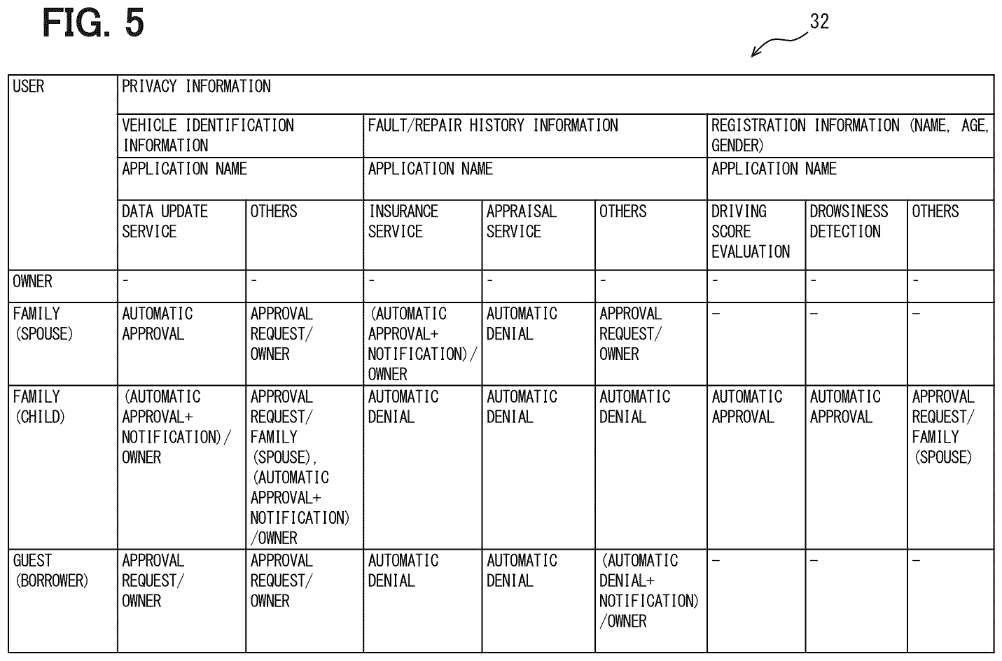

As shown in FIG. 5, the authorization process management table 32 is data for defining the authorization process for users who do not have authorization rights. The authorization process is set for each of the plurality of users, each of the plurality of privacy information, and each of the plurality of applications. In FIG. 5, the “−” column where the authorization process is not defined indicates that the user has authorization rights and the application can access the privacy information without going through the authorization process. In other words, the authorization process management table 32 also includes information on whether the user has authorization rights.

For example, when the application “data update service” accesses vehicle identification information, if the user is the owner, the authorization process is not required because the user has authorization rights. If the user is a family member (spouse), family member (child), or guest (borrower), the authorization process defined in FIG. 5 is followed. When the application “insurance service” accesses fault/repair history information, if the user is the owner, the authorization process is not required because the user has authorization rights. If the user is a family member (spouse), family member (child), or guest (borrower), the authorization process defined in FIG. 5 is followed. When the application “driving score evaluation” accesses registration information (user's name, age, gender), if the user is the owner, family member (spouse), or guest (borrower), the authorization process is not required because the user has authorization rights. If the user is a family member (child), the authorization process of automatic approval is followed. When applications other than “driving score evaluation” and “drowsiness detection” access registration information, if the user is the owner, family member (spouse), or guest (borrower), the authorization process is not required because the user has authorization rights. If the user is a family member (child), the authorization process of requesting approval from the family member (spouse) is followed.

The authorization process includes the process content and the approval or notification destination.

In the present embodiment, the types of process content are five types: “approval request,” “automatic approval,” “automatic approval+notification,” “automatic denial,” and “automatic denial+notification.”

“Approval request” is a process that requests approval from the approval destination included in the authorization process.

“Automatic approval” is a process that is already approved by the user with authorization rights and is automatically approved.

“Automatic approval+notification” is a process that automatically approves and further notifies the notification destination included in the authorization process that the approval has been granted.

“Automatic denial” is a process that is already denied by the user with authorization rights and is automatically denied.

“Automatic denial+notification” is a process that automatically denies and further notifies the notification destination included in the authorization process that the denial has been made.

In the authorization process management table 32 shown in FIG. 5, vehicle identification information, fault/repair history information, and registration information are set as privacy information. Registration information includes name, age, and gender.

Applications that use vehicle identification information include a data update service application and applications other than the data update service. Applications that use fault/repair history information include an insurance service application, an appraisal service application, and applications other than the insurance service and appraisal service. Applications that use registration information include a driving score evaluation application, a drowsiness detection application, and applications other than the driving score evaluation and drowsiness detection.

The authorization process management table 32 indicates that the vehicle owner does not need the definition of the authorization process for all applications, and the vehicle owner's spouse and guest do not need the definition of the authorization process for applications that use registration information.

When the vehicle owner's spouse uses the data update service application and this application attempts to use vehicle identification information, it is automatically approved.

When the vehicle owner's child uses the data update service application and this application attempts to use vehicle identification information, it is automatically approved, and the approval is notified to the vehicle owner's information terminal.

When a guest uses the data update service application and this application attempts to use vehicle identification information, an approval request is sent to the vehicle owner's information terminal. If the vehicle owner's approval is obtained, the data update service application can use the vehicle identification information. On the other hand, if the vehicle owner denies, the data update service application cannot use the vehicle identification information.

When the vehicle owner's spouse or guest uses an application other than the data update service and this application attempts to use vehicle identification information, an approval request is sent to the vehicle owner's information terminal. If the vehicle owner's approval is obtained, this application can use the vehicle identification information.

When the vehicle owner's child uses an application other than the data update service and this application attempts to use vehicle identification information, an approval request is sent to the vehicle owner's spouse's information terminal. If the vehicle owner's spouse's approval is obtained, it is automatically approved, and the approval is notified to the vehicle owner's information terminal.

When the vehicle owner's spouse uses the insurance service application and this application attempts to use fault/repair history information, it is automatically approved, and the approval is notified to the vehicle owner's information terminal.

When the vehicle owner's child or guest uses the insurance service application and this application attempts to use fault/repair history information, it is automatically denied.

When the vehicle owner's spouse, the vehicle owner's child, or a guest uses the appraisal service application and this application attempts to use fault/repair history information, it is automatically denied.

When the vehicle owner's spouse uses an application other than the insurance service and appraisal service and this application attempts to use fault/repair history information, an approval request is sent to the vehicle owner's information terminal. If the vehicle owner's approval is obtained, this application can use the fault/repair history information.

When the vehicle owner's child uses an application other than the insurance service and appraisal service and this application attempts to use fault/repair history information, it is automatically denied.

When a guest uses an application other than the insurance service and appraisal service and this application attempts to use fault/repair history information, it is automatically denied, and the denial is notified to the vehicle owner's information terminal. This allows, for example, the collection of information on which applications use privacy information that the user does not want to be used carelessly.

When the vehicle owner's child uses the driving score evaluation or drowsiness detection application and this application attempts to use registration information, it is automatically approved.

When the vehicle owner's child uses an application other than the driving score evaluation and drowsiness detection and this application attempts to use registration information, an approval request is sent to the vehicle owner's spouse's information terminal. If the vehicle owner's spouse's approval is obtained, this application can use the registration information.

Next, privacy information is broadly classified into the privacy information of the vehicle owner, the privacy information of the person using the vehicle, and the privacy information directly linked to each individual.

Examples of the vehicle owner's privacy information include vehicle identification information. Examples of the privacy information of the person using the vehicle include current location information, destination information, and a driver monitor image. Examples of privacy information directly linked to each individual include registration information (e.g., name, age, gender, and height) and mobile terminal ID (e.g., phone number).

The vehicle owner's privacy information belongs to the vehicle owner. Privacy information directly linked to each individual belongs to each individual. Belonging means whose ownership data the privacy information is.

The privacy information of the person using the vehicle varies in belonging depending on the timing and other factors when it is stored in the vehicle.

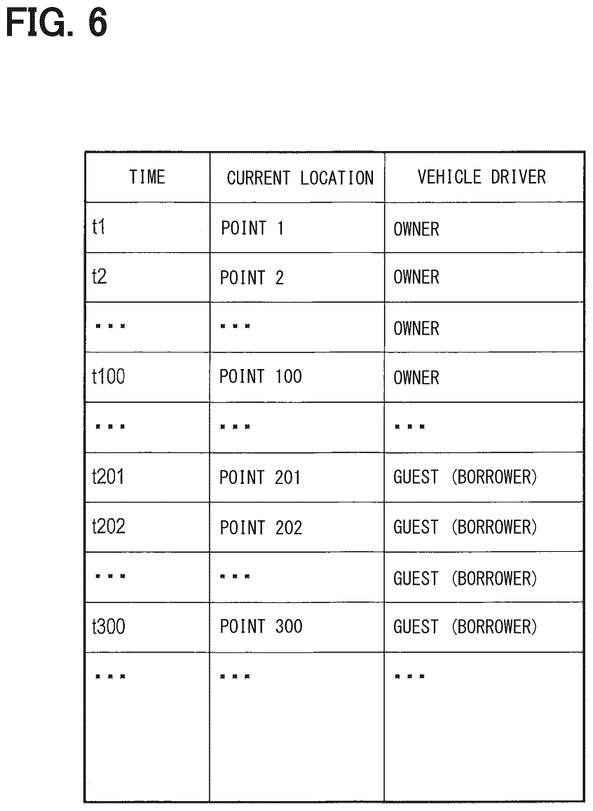

For example, as shown in FIG. 6, privacy information indicating the current location belongs to the driver at the timing when it is stored in the vehicle. In FIG. 6, the current location information from time t1 to time t100 (i.e., information from point 1 to point 100) belongs to the owner who is the driver from time t1 to time t100. The current location information from time t201 to time t300 (i.e., information from point 201 to point 300) belongs to the guest who is the driver from time t201 to time t300.

Thus, each of the vehicle function blocks 15, 16, and 17, every time privacy information of the person using the vehicle is stored, associates the driver at the timing of storage in the vehicle function databases 21, 22, and 23 as the owner, and stores this owner and the privacy information linked together in the vehicle function databases 21, 22, and 23. The driver of the vehicle is identified by authentication in the user authentication unit 13. Therefore, the ECU 2 transmits the belonging information indicating the user authenticated by the user authentication unit 13 to the ECUs 3 and 4. As a result, the ECUs 3 and 4 can acquire the belonging information from the ECU 2 and store the privacy information (e.g., current location information, destination information, and a driver monitor image) linked with the belonging information.

Next, a procedure will be described in which the service application 11 acquires vehicle identification information from the vehicle function block 15 when a guest is driving the vehicle.

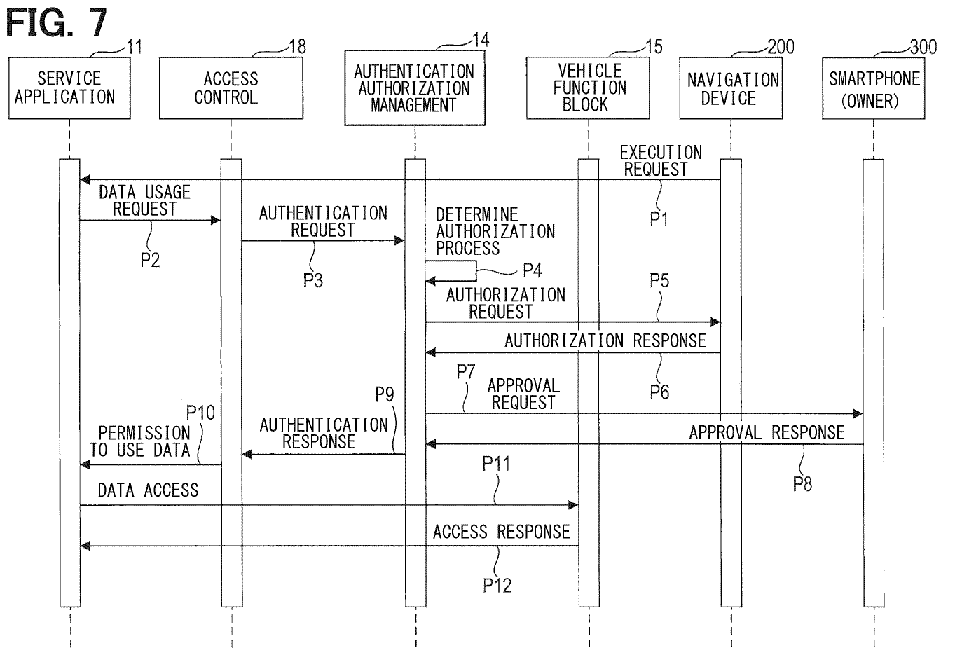

When a guest is driving the vehicle, as shown in process P1 of FIG. 7, the navigation device 200 mounted on the vehicle transmits an execution request to the service application 11. When the service application 11 receives the execution request, it transmits a data usage request for vehicle identification information to the access control unit 18, as shown in process P2. The data usage request includes source information indicating the application that is the source of the transmission and request data information indicating the data that is the target of the data usage request.

When the access control unit 18 receives the data usage request for vehicle identification information, it transmits a user authentication request to the authentication authorization management unit 14 to request authentication for the user to use the vehicle identification information, as shown in process P3. The user authentication request includes request application information indicating the application that transmitted the data usage request and request data information indicating the data that is the target of the data usage request.

When the authentication authorization management unit 14 receives the user authentication request, it determines the authorization process for the service application 11 to use the vehicle identification information when the guest is driving the vehicle, as shown in process P4.

When the authentication authorization management unit 14 determines the authorization process, it transmits an authorization request to the navigation device 200 to use the vehicle identification information, as shown in process P5.

When the navigation device 200 receives the authorization request, it transmits an authorization response to the authentication authorization management unit 14 to authorize the use of the vehicle identification information, as shown in process P6.

When the authentication authorization management unit 14 receives the authorization response, it transmits an approval request to the smartphone 300 possessed by the vehicle owner to request approval for the use of the vehicle identification information, as shown in process P7, if the information terminal is a smartphone.

When the smartphone 300 receives the approval request, it displays an image on the display screen of the smartphone 300 to confirm whether to approve the use of the vehicle identification information by the guest. When the vehicle owner performs an operation to approve the use of the vehicle identification information by the guest, the smartphone 300 transmits an approval response to the authentication authorization management unit 14, as shown in process P8.

When the authentication authorization management unit 14 receives the approval response, it transmits a user authentication response to the access control unit 18, as shown in process P9.

When the access control unit 18 receives the user authentication response, it transmits a permission to use the vehicle identification information to the service application 11, as shown in process P10.

When the service application 11 receives the permission to use the vehicle identification information, it accesses the vehicle function block 15 to acquire the vehicle identification information, as shown in process P11.

In response to the access from the service application 11, the vehicle function block 15 transmits the vehicle identification information to the service application 11, as shown in process P12.

Next, the procedure for the authentication authorization management unit 14 to determine the authorization process will be described.

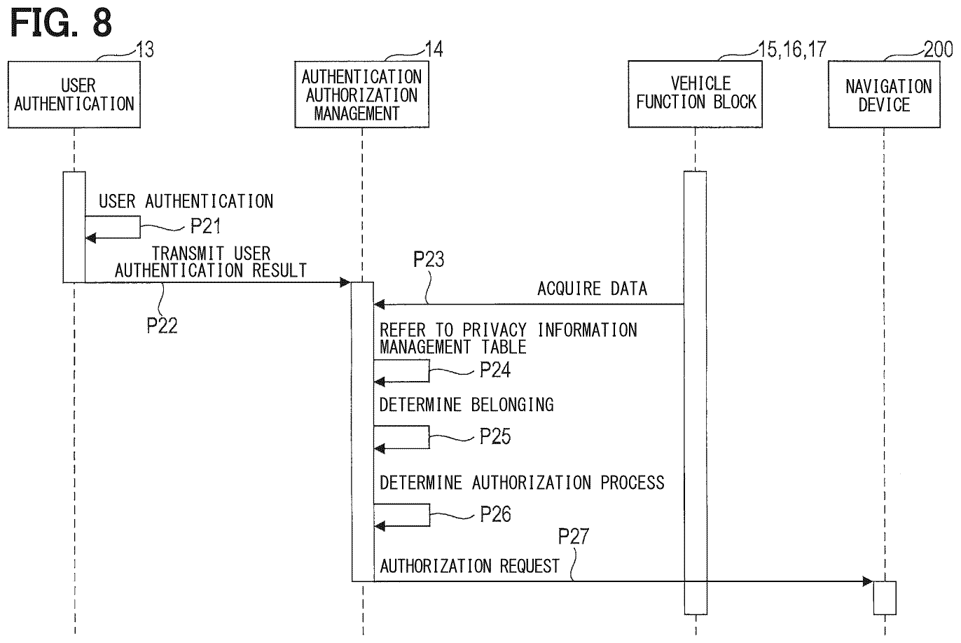

As shown in process P21 of FIG. 8, the user authentication unit 13 authenticates the vehicle user (i.e., the driver). User authentication is performed using at least one of login authentication, device authentication, and biometric authentication. Login authentication is an authentication method that identifies the user by having the user input a login ID and password into, for example, the navigation device 200. Device authentication is an authentication method that identifies the user by performing data communication with a device possessed by the user (e.g., a smartphone or smart key). Biometric authentication is an authentication method that identifies the user by analyzing the user's fingerprint, vein, voiceprint, face, etc.

When the user authentication unit 13 identifies the user through user authentication, the user authentication unit 13 transmits a user authentication result indicating the identified user to the authentication authorization management unit 14, as shown in process P22.

Subsequently, when the authentication authorization management unit 14 receives a user authentication request from the access control unit 18, the authentication authorization management unit 14 acquires the data to be used from the vehicle function block 15, the vehicle function block 16, or the vehicle function block 17, as shown in process P23. For example, when a user authentication request that targets current location information is received, the authentication authorization management unit 14 acquires the current location information from the vehicle function block 15.

Next, as shown in process P24, the authentication authorization management unit 14 refers to the privacy information management table 31 to confirm the belonging of the data acquired in process P23. For example, if the data targeted by the user authentication request is vehicle identification information, the belonging is only the vehicle owner. If the data targeted by the user authentication request is current location information, the belonging includes the vehicle owner, the vehicle owner's spouse, the vehicle owner's child, and the guest.

Further, as shown in process P25, the authentication authorization management unit 14 determines the belonging of the data. The determination of belonging is performed according to the following first pattern or second pattern.

The first pattern is a pattern in which the belonging can be uniquely determined by referring to the privacy information management table 31. For example, if the data targeted is vehicle identification information, the belonging is determined to be the vehicle owner by referring to the privacy information management table 31.

The second pattern is a pattern in which the belonging cannot be uniquely determined by referring to the privacy information management table 31, and the belonging is determined by referring to the belonging information attached to the data. For example, if the data targeted is current location information, the belonging is determined based on the belonging information attached to the current location information.

Next, as shown in process P26, the authentication authorization management unit 14 determines the authorization process based on the belonging of the data, the user authentication result, the privacy information management table 31, and the authorization process management table 32.

Specifically, the authentication authorization management unit 14 first determines whether the current vehicle user has authorization rights for the data targeted based on the belonging of the data, the user authentication result, and the privacy information management table 31.

If it is determined that the user has authorization rights, the authentication authorization management unit 14 decides that the authorization process is unnecessary. On the other hand, if it is determined that the user does not have authorization rights, the authentication authorization management unit 14 determines the authorization process based on the authorization process management table 32.

Then, as shown in process P27, the authentication authorization management unit 14 transmits an authorization request to the navigation device 200 to use the data targeted.

Next, the procedure until the access control unit 18 transmits a user authentication request will be described.

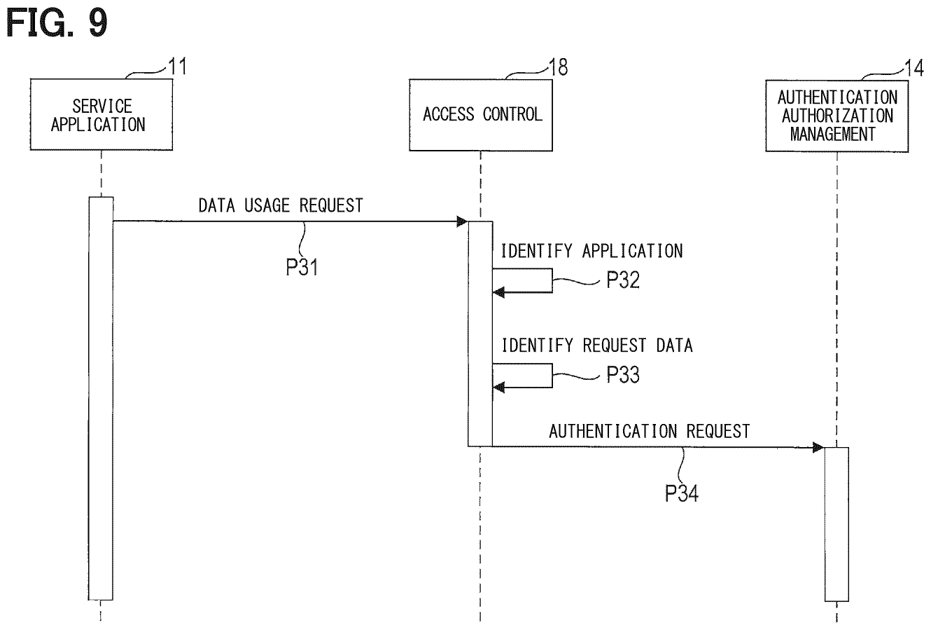

As shown in process P31 of FIG. 9, when the service application 11 transmits a data usage request to the access control unit 18, the access control unit 18 identifies the application that is the source of the data usage request based on the source information included in the data usage request, as shown in process P32.

Further, as shown in process P33, the access control unit 18 identifies the data targeted for use based on the request data information included in the data usage request.

Then, as shown in process P34, the access control unit 18 transmits a user authentication request to the authentication authorization management unit 14. The user authentication request includes the request application information identifying the application specified in process P32 and the request data information identifying the data specified in process P33.

The vehicle control system 1 configured in this manner includes the service applications 11 and 12, the vehicle function blocks 15, 16, and 17, the authentication authorization management unit 14, the privacy information management table 31, and the authorization process management table 32.

The service applications 11 and 12 are configured to provide services to users utilizing the vehicle by using vehicle information related to the vehicle.

The vehicle function blocks 15, 16, and 17 are configured to acquire vehicle information held by the ECUs 2, 3, and 4 mounted on the vehicle.

The authentication authorization management unit 14 is configured to determine whether to authorize a data usage request when the service applications 11 and 12 issue a data usage request to provide privacy information among the vehicle information via the vehicle function blocks 15, 16, and 17.

The privacy information management table 31 defines the user who has authorization rights for each of the plurality of privacy information.

The authorization process management table 32 defines an authorization process for authorizing the data usage request for each of the plurality of users and for each of the plurality of privacy information.

The authentication authorization management unit 14 determines the authorization process based on the privacy information management table 31 and the authorization process management table 32, and determines whether to authorize the data usage request using the determined authorization process.

In such a vehicle control system 1, when a data usage request is made by the service applications 11 and 12, the user who has authorization rights for the privacy information targeted by the data usage request is identified. Furthermore, the system determines whether to authorize the data usage request using the authorization process determined for each vehicle user and for each privacy information. If necessary, the vehicle control system 1 can include a process that requires approval from the user who has authorization rights in the authorization process.

Thus, the vehicle control system 1 can determine whether to provide the privacy information targeted by the data usage request to the service applications 11 and 12 based on the authorization process determined based on the user who has authorization rights, the vehicle user, and the privacy information. As a result, the vehicle control system 1 can prevent situations where the service applications 11 and 12 cannot acquire the necessary privacy information and thus fail to provide appropriate services to the vehicle user, or where privacy information that should not be provided is given to the service applications 11 and 12. Therefore, the vehicle control system 1 can improve convenience for vehicle users and suppress the inappropriate acquisition of privacy information.

The vehicle control system 1 also includes a user authentication unit 13 configured to authenticate the vehicle user. When the vehicle function blocks 15, 16, and 17 acquire belonging assignment information that needs to be linked with the belonging, such as current location information, destination information, and a driver monitor image, among the plurality of privacy information, the vehicle function blocks 15, 16, and 17 link the acquired belonging assignment information with the belonging information indicating the user authenticated by the user authentication unit 13 and store the acquired belonging assignment information. The ECUs 3 and 4 may be pre-configured to recognize whether the information is belonging assignment information or may receive information from the ECU 2 indicating whether the information is belonging assignment information.

As a result, the vehicle control system 1 can set an appropriate authorization process based on the belonging of the privacy information, thereby further improving the convenience for vehicle users and further suppressing the inappropriate acquisition of privacy information.

The authorization process management table 32 further defines the authorization process for each service application.

The vehicle control system 1 also includes the access control unit 18. The access control unit 18 is configured to manage the transmission and reception of data between the service applications 11 and 12 and the vehicle function blocks 15, 16, and 17. When the access control unit 18 acquires a data usage request from the service applications 11 and 12, it is configured to identify the service applications 11 and 12 that are the source of the data usage request. The authentication authorization management unit 14 is configured to determine the authorization process based on the service applications 11 and 12 identified by the access control unit 18, the privacy information management table 31, and the authorization process management table 32.

In such a vehicle control system 1, different authorization processes can be set for the service application 11 and the service application 12. As a result, the vehicle control system 1 can further prevent the occurrence of a situation in which the service applications 11 and 12 cannot acquire the necessary privacy information and thus fail to provide appropriate services to the vehicle user, or privacy information that should not be provided is provided to the service applications 11 and 12. Therefore, the vehicle control system 1 can further improve the convenience for vehicle users and further suppress the inappropriate acquisition of privacy information.

The authorization process defined in the authorization process management table 32 includes an approval request process that requests approval for the data usage request from a predetermined approver, and authorizes the data usage request if approval is obtained from the approver. This allows the vehicle control system 1 to determine whether to authorize the data usage request based on the judgment of the approver.

The authorization process defined in the authorization process management table 32 includes an automatic approval process that authorizes the data usage request without requesting approval for the data usage request from a predetermined approver. This reduces the frequency with which the approver needs to perform tasks for approval or denial.

The authorization process defined in the authorization process management table 32 includes an automatic approval notification process that authorizes the data usage request without requesting approval for the data usage request from a predetermined approver and notifies the approver that the data usage request has been authorized. This reduces the frequency with which the approver needs to perform tasks for approval or denial and allows the approver to be aware that a data usage request has been made.

The authorization process defined in the authorization process management table 32 includes an automatic denial process that denies the data usage request without requesting approval for the data usage request from a predetermined approver. This reduces the frequency with which the approver needs to perform tasks for denial.

The authorization process defined in the authorization process management table 32 includes an automatic denial notification process that denies the data usage request without requesting approval for the data usage request from a predetermined approver and notifies the approver that the data usage request has been denied. This reduces the frequency with which the approver needs to perform tasks for denial and allows the approver to be aware that a data usage request has been made.

The authentication authorization management unit 14 is configured to determine whether the user has authorization rights based on the privacy information management table 31, and if the user does not have authorization rights, to determine the authorization process based on the authorization process management table 32.

The ECU 2 includes the authentication authorization management unit 14, the privacy information management table 31, the authorization process management table 32, and the vehicle function block 17. The vehicle function block 17 is configured to acquire privacy information when the data usage request is authorized by the authentication authorization management unit 14. The authentication authorization management unit 14 determines the authorization process based on the privacy information management table 31 and the authorization process management table 32, and determines whether to authorize the data usage request using the determined authorization process.

Such an ECU 2 can further improve the convenience for vehicle users and further suppress the inappropriate acquisition of privacy information, similarly to the vehicle control system 1.

In the embodiment described above, the vehicle control system 1 corresponds to an authentication system, the ECUs 3 and 4 correspond to electronic control units, the privacy information management table 31 corresponds to a confidential information management table, the privacy information corresponds to confidential information, the data usage request corresponds to a confidential information acquisition request, and the ECU 2 corresponds to an authentication device.

The ECUs 3 and 4 correspond to the first electronic control unit, the ECU 2 corresponds to the second electronic control unit, the vehicle function databases 21 and 22 correspond to the first storage, the vehicle function blocks 15 and 16 correspond to the first vehicle function block, and the vehicle function block 17 corresponds to the second vehicle function block.

Although the embodiment of the present disclosure has been described above, the present disclosure is not limited to the above embodiment and can be implemented with various modifications.

### First Modification

For example, in the above embodiment, the service applications 11 and 12 are shown to be installed in the ECU 2, but they may be installed in the ECUs 3, 4, and the vehicle external communication device 5. The service applications 11 and 12 may also be installed in a center placed outside the vehicle and configured to communicate data with the vehicle external communication device 5.

### Second Modification

In the above embodiment, the user authentication unit 13, the authentication authorization management unit 14, and the access control unit 18 are shown to be installed in the ECU 2, but they may be installed in the ECUs 3, 4, and the vehicle external communication device 5. The user authentication unit 13, the authentication authorization management unit 14, and the access control unit 18 may also be installed in different devices.

### Third Modification

In the above embodiment, the authorization process is determined based on the privacy information management table 31 and the authorization process management table 32. However, the authorization process may be determined based solely on the authorization process management table 32 without using the privacy information management table 31.

That is, in the authorization process management table 32, the “−” column where the authorization process is not defined indicates that the user has authorization rights for the privacy information. Therefore, it is possible to determine whether the user has authorization rights based solely on the authorization process management table 32.

For example, when the application “data update service” accesses vehicle identification information, it can be determined based on the authorization process management table 32 that the owner has authorization rights, and the family (spouse), family (child), and guest (borrower) do not have authorization rights.

Similarly, when the application “driving score evaluation” accesses registration information (user's name, age, gender), it can be determined based on the authorization process management table 32 that the owner, family (spouse), and guest (borrower) have authorization rights, and the family (child) does not have authorization rights.

### Fourth Modification

In the above embodiment, the vehicle function databases 21 and 22 are shown to be installed in different ECUs 3. However, the vehicle function databases that store the collected vehicle information may be installed in the ECUs 4 or the ECU 2 in addition to the ECUs 3.

### Fifth Modification

In the above embodiment, the privacy information of the vehicle user is shown as confidential information. However, information that is not related to privacy but should not be accessed without permission (e.g., key information held by the ECUs 2, 3, and 4) may be included as confidential information.

The ECUs 2 and 3 and their methods described in the present disclosure may be implemented by a dedicated computer provided by configuring a processor and a memory programmed to execute one or more functions embodied by a computer program. Alternatively, the ECUs 2 and 3 and their methods described in the present disclosure may be implemented by a dedicated computer provided by configuring a processor with one or more dedicated hardware logic circuits. Alternatively, the ECUs 2 and 3 and their methods described in the present disclosure may be implemented by one or more dedicated computers configured by a combination of a processor and a memory programmed to perform one or a plurality of functions and a processor configured with one or more hardware logic circuits. Further, the computer program may be stored in a computer-readable non-transitory tangible storage medium as instructions to be executed by a computer. The technique for implementing the functions of each unit included in the ECUs 2 and 3 does not necessarily need to include software, and all the functions may be implemented using one or a plurality of hardware circuits.

A plurality of functions belonging to one configuration element in the above-described embodiment may be implemented by a plurality of configuration elements, or one function belonging to one configuration element may be implemented by a plurality of configuration elements. A plurality of functions belonging to a plurality of configuration elements may be implemented by one configuration element, or one function implemented by a plurality of configuration elements may be implemented by one configuration element. Further, a part of the configuration of the above embodiment may be omitted. At least a part of the configuration of the embodiment may be added to or replaced with another configuration of the embodiment.

In addition to the above-described ECUs 2 and 3, the present disclosure can also be implemented in various forms such as a system including the ECUs 2 and 3 as components, a program for causing a computer to function as the ECUs 2 and 3, a non-transitory tangible storage medium such as a semiconductor memory storing the program, and an authentication method.

What is claimed is:

1. An authentication system comprising:
at least one service application configured to provide a service to a user utilizing a vehicle, by using vehicle information related to the vehicle;
a vehicle function block configured to acquire the vehicle information held by an electronic control unit mounted on the vehicle;
an authentication authorization management unit configured to determine whether to authorize a confidential information acquisition request when the at least one service application issues the confidential information acquisition request to acquire confidential information among the vehicle information via the vehicle function block;
a confidential information management table defining a user who has authorization rights for each of a plurality of confidential information; and
an authorization process management table defining an authorization process for authorizing the confidential information acquisition request for each of a plurality of users and for each of the plurality of confidential information,
wherein
the authentication authorization management unit determines the authorization process based on the confidential information management table and the authorization process management table, and determines whether to authorize the confidential information acquisition request using the determined authorization process.

2. The authentication system according to claim 1, further comprising:
a user authentication unit configured to authenticate the user,
wherein
the vehicle function block, upon acquiring belonging assignment information that is set in advance as information that needs to be associated with belonging of the confidential information among the plurality of confidential information, associates the obtained belonging assignment information with the belonging information indicating the user authenticated by the user authentication unit, and stores the obtained belonging assignment information.

3. The authentication system according to claim 2, wherein
the user authentication unit is configured to authenticate a user using at least one of login authentication, device authentication, and biometric authentication.

4. The authentication system according to claim 1, wherein
the authorization process management table further defines the authorization process for each of the at least one service application.

5. The authentication system according to claim 4, further comprising:
an access control unit configured to manage transmission and reception of data between the at least one service application and the vehicle function block,
wherein
the access control unit is configured to identify the at least one service application that is a transmission source of the confidential information acquisition request when acquiring the confidential information acquisition request from the at least one service application, and
the authentication authorization management unit is configured to determine the authorization process based on the at least one service application identified by the access control unit, the confidential information management table, and the authorization process management table.

6. The authentication system according to claim 1, wherein
the authorization process includes an approval request process that requests approval for the confidential information acquisition request from a predetermined approver, and authorizes the confidential information acquisition request when approval is obtained from the approver.

7. The authentication system according to claim 1, wherein
the authorization process includes an automatic approval process that authorizes the confidential information acquisition request without requesting approval for the confidential information acquisition request from a predetermined approver.

8. The authentication system according to claim 1, wherein
the authorization process includes an automatic approval notification process that authorizes the confidential information acquisition request without requesting approval for the confidential information acquisition request from a predetermined approver and notifies the approver that the confidential information acquisition request has been authorized.

9. The authentication system according to claim 1, wherein
the authorization process includes an automatic denial process that denies the confidential information acquisition request without requesting approval for the confidential information acquisition request from a predetermined approver.

10. The authentication system according to claim 1, wherein
the authorization process includes an automatic denial notification process that denies the confidential information acquisition request without requesting approval for the confidential information acquisition request from a predetermined approver and notifies the approver that the confidential information acquisition request has been denied.

11. The authentication system according to claim 1, wherein
the authentication authorization management unit determines whether the user has authorization rights based on the confidential information management table, and when the user does not have authorization rights, determines the authorization process based on the authorization process management table.

12. An authentication device comprising:
an authentication authorization management unit configured to determine whether to authorize a confidential information acquisition request when at least one service application configured to provide a service to a user utilizing a vehicle by using vehicle information related to the vehicle issues the confidential information acquisition request to acquire confidential information among the vehicle information;
a confidential information management table defining the user who has authorization rights for each of a plurality of confidential information;
an authorization process management table defining an authorization process for authorizing the confidential information acquisition request for each of a plurality of users and for each of the plurality of confidential information; and
a vehicle function block configured to acquire the confidential information when the confidential information acquisition request is authorized by the authentication authorization management unit,
wherein
the authentication authorization management unit determines the authorization process based on the confidential information management table and the authorization process management table, and determines whether to authorize the confidential information acquisition request using the determined authorization process.

13. A non-transitory computer readable storage medium storing an authentication program for causing a computer to function as:
an authentication authorization management unit configured to determine whether to authorize a confidential information acquisition request when at least one service application configured to provide a service to a user utilizing a vehicle by using vehicle information related to the vehicle issues the confidential information acquisition request to acquire confidential information among the vehicle information, based on a confidential information management table defining the user who has authorization rights for each of a plurality of confidential information and an authorization process management table defining an authorization process for authorizing the confidential information acquisition request for each of a plurality of users and for each of the plurality of confidential information, and using the determined authorization process; and
a vehicle function block configured to acquire the confidential information when the confidential information acquisition request is authorized by the authentication authorization management unit.

14. An authentication system comprising:
a first electronic control unit configured to manage vehicle information related to a vehicle;
a second electronic control unit having a function of relaying data transmitted from a plurality of the first electronic control units,
wherein
the first electronic control unit includes:
a first storage configured to store the vehicle information; and
a first vehicle function block configured to acquire the vehicle information,
the second electronic control unit includes:
at least one service application configured to provide a service to a user utilizing the vehicle by using the vehicle information;
a second vehicle function block configured to acquire the vehicle information from the first electronic control unit;
an authentication authorization management unit configured to determine whether to authorize a confidential information acquisition request when the at least one service application issues the confidential information acquisition request to acquire confidential information among the vehicle information held by the first electronic control unit;
a confidential information management table defining the user who has authorization rights for each of a plurality of confidential information; and
an authorization process management table defining an authorization process for authorizing the confidential information acquisition request for each of a plurality of users and for each of the plurality of confidential information,
wherein
the authentication authorization management unit determines the authorization process based on the confidential information management table and the authorization process management table, and determines whether to authorize the confidential information acquisition request using the determined authorization process,
when the confidential information acquisition request is authorized by the authentication authorization management unit, the at least one service application acquires the confidential information via the first vehicle function block of the first electronic control unit or the second vehicle function block of the second electronic control unit that stores the confidential information corresponding to the confidential information acquisition request.

15. The authentication system according to claim 14, wherein
the first vehicle function block stores the confidential information in the first storage by linking the confidential information with belonging information indicating belonging if the confidential information is belonging assignment information that needs to be linked with the belonging.
